(19) United States
(12) Patent Application Publication
(10) Pub. No.: US 2014/0111488 A1
(43) Pub. Date: Apr. 24, 2014

(54) STYLUS PEN AND INFORMATION DEVICE

(71) Applicant: Kabushiki Kaisha Toshiba, Tokyo (JP)

(72) Inventors: Saori MICHIHATA, Sagamihara-shi (JP); Toshiya TAKANO, Sagamihara-shi (JP)

(21) Appl. No.: 13/916,987

(22) Filed: Jun. 13, 2013

(30) Foreign Application Priority Data
Oct. 18, 2012 (JP) 2012-231073

(51) Int. Cl. G06F 3/0354

(52) U.S. Cl. CPC G06F 3/03545
USPC 345/179

(57) ABSTRACT

One embodiment provides a stylus pen configured to be used as an input pen in a tablet input device. The stylus pen includes a pen tip including a high friction material, and a portion of the pen tip includes an approximately spherical shape. The stylus pen further includes a touch point and a touch point clarifying structure. The touch point clarifying structure is configured to enhance a visibility of the touch point of the stylus pen to a touching object.

### CROSS-REFERENCE TO RELATED APPLICATION(S)

This application claims priority/priorities from Japanese Patent Application No. 2012-231073 filed on Oct. 18, 2012, the entire contents of which are incorporated herein by reference.

### FIELD

Embodiments described herein relate generally to a stylus pen as an input pen for electronic device, and an information device equipped with this stylus pen.

### BACKGROUND

For example, a stylus pen is used as an input device in a tablet input device. A stylus pen having a thick pen core may be inferior in usability in writing small characters as compared with a ball point pen.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 perspectively shows an exemplary electronic device according to an embodiment.

FIG. 2 shows the system configuration of the electronic device.

FIGS. 3A-3C cross-sectionally show the shape of a pen core in (Example 1).

FIGS. 4A-4B cross-sectionally show the shape of a pen core in (Example 2).

FIGS. 5A-5B cross-sectionally show the shape of a pen core in (Example 3).

FIGS. 6A-6B cross-sectionally show the shape of a pen core in (Example 4).

FIG. 7 cross-sectionally shows the shape of a pen core in (Example 5).

FIG. 8 cross-sectionally shows the shape of a pen core in (Example 6).

### DETAILED DESCRIPTION

One embodiment provides a stylus pen configured to be used as an input pen in a tablet input device, the stylus pen including: a pen tip comprising a high friction material, wherein a portion of the pen tip comprises an approximately spherical shape; a touch point; and a touch point clarifying structure configured to enhance a visibility of the touch point of the stylus pen to a touching object.

An embodiment will be described below with reference to the drawings.

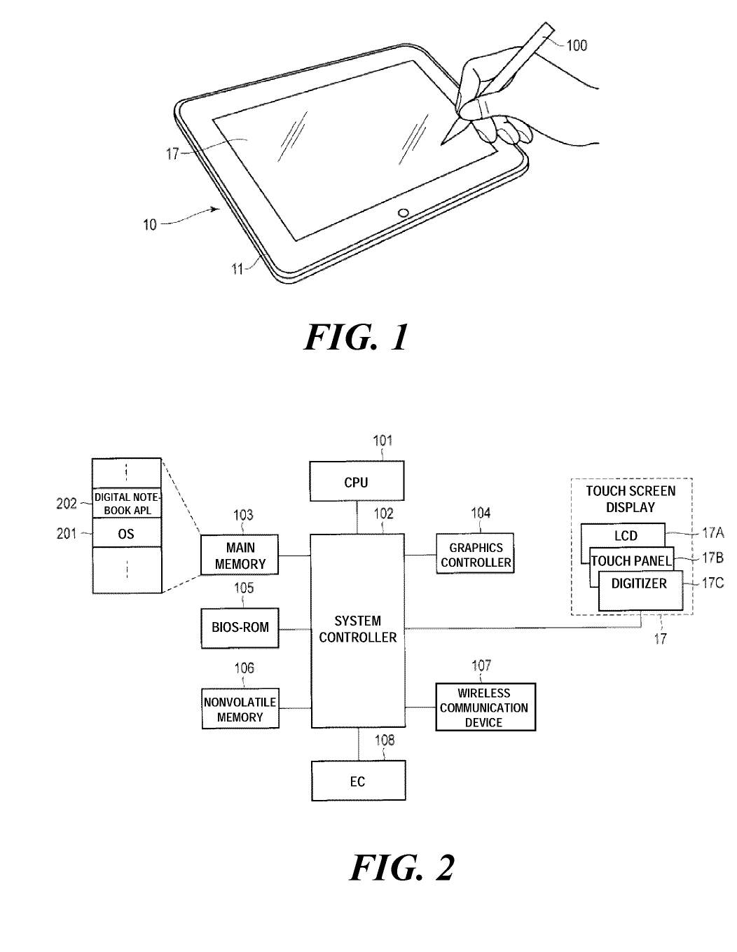

FIG. 1 perspectively shows an exemplary electronic device which is an embodiment of an information device. For example, the electronic device is a pen-based portable electronic device into which input can be done by handwriting with a pen or a finger. The electronic device can be implemented as a tablet computer, a notebook type personal computer, a smartphone, a PDA, etc. Assume now that the electronic device is implemented as a tablet computer 10. The tablet computer 10 is a portable electronic device referred to as tablet or slate computer. As shown in FIG. 1, the tablet computer 10 has a body 11, and a touch screen display 17. The touch screen display 17 is attached so as to be laid on an upper surface of the body 11.

The body 11 has a housing shaped like a thin box. A flat panel display and sensors configured to detect a touch position of a pen or a finger on a screen of the flat panel display are incorporated in the touch screen display 17. For example, the flat panel display may be a liquid crystal display device (LCD). For example, a capacitance type touch panel, an electromagnetic induction type digitizer, etc. can be used as the sensors. Assume now that a digitizer and a touch panel which are two kinds of sensors are incorporated in the touch screen display 17.

Each of the digitizer and the touch panel is provided to cover the screen of the flat panel display. The touch screen display 17 can detect not only a touch operation using a finger on the screen but also a touch operation using a pen 100 on the screen. For example, the pen 100 may be an electromagnetic induction pen. A user can perform a handwriting input operation on the touch screen display 17 by using an external object (the pen 100 or a finger). During the handwriting input operation, the locus of motion of the external object (the pen 100 or the finger) on the screen, that is, the locus (handwriting) of each stroke handwritten by the handwriting input operation is drawn in real time, so that the locus of each stroke is displayed on the screen. The locus of motion of the external object in the duration that the external object touches the screen corresponds to one stroke. A set of lots of strokes corresponding to handwritten characters, figures, etc., that is, a set of lots of loci (handwriting) forms a handwritten document.

In this embodiment, the handwritten document is stored not as image data but as time-series information indicating a series of coordinates of loci of respective strokes and a sequence of the respective strokes in a storage medium. The time-series information generally means a set of time-series stroke data corresponding to a plurality of strokes respectively. Each stroke data corresponds to one stroke and includes a series of coordinate data (time-series coordinates) corresponding to respective points on the locus of this stroke. The sequence of arrangement of these stroke data corresponds to a sequence of handwritten strokes, that is, the stroke order.

The tablet computer 10 can read existing arbitrary time-series information from a recording medium and display a handwritten document corresponding to the time-series information, that is, loci corresponding to respective strokes indicated by the time-series information on the screen. The tablet computer 10 further has an editing function. By the editing function, any stroke or any handwritten character or the like in the displayed handwritten document can be erased or moved in accordance with an editing operation of a user using various tools such as an “eraser” tool, a range designation tool, etc. The editing function may further include a function of removing some parts of a history of handwriting operation.

In this embodiment, the time-series information (handwritten document) may be managed as one page or a plurality of pages. In this case, the time-series information (handwritten document) may be separated by an area which can be put in one screen so that a lump of time-series information which can be put in one screen can be recorded as one page. Alternatively, configuration may be made so that the size of one page can be changed. In this case, the size of one page can be enlarged to an area larger than the size of one screen, so that a handwritten document with an area larger than the screen size can be handled as one page. When one page cannot be entirely displayed on the display at a time, configuration may be made so that the page can be scaled down or a display-target portion in the page can be moved by vertical and horizontal scrolling.

FIG. 2 shows the system configuration of the tablet computer 10.

As shown in FIG. 2, the tablet computer 10 has a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor which controls operation of various modules in the tablet computer 10. The CPU 101 executes various softwares loaded onto the main memory 103 from the nonvolatile memory 106 which is a storage device. These softwares include an operating system (OS) 201, and various application programs. The application programs include a digital notebook application program 202. For example, the digital notebook application program 202 has a function of creating and displaying the handwritten document, a function of editing the handwritten document, and a character/figure recognition function.

The CPU 101 also executes a basic input/output system (BIOS) stored in the BIOS-ROM 105. The BIOS is a program for hardware control.

The system controller 102 is a device which connects various components to a local bus of the CPU 101. The system controller 102 has a built-in memory controller for access control of the main memory 103. The system controller 102 further has a function of executing communication with the graphics controller 104 through a PCI EXPRESS-based serial bus or the like.

The graphics controller 104 is a display controller which controls an LCD 17A used as a display monitor of the tablet computer 10. A display signal generated by the graphics controller 104 is fed to the LCD 17A. The LCD 17A displays a screen image based on the display signal. A touch panel 17B and a digitizer 17C are disposed on the LCD 17A. The touch panel 17B is a capacitance type pointing device for inputting on a screen of the LCD 17A. A touch position of a finger on the screen, the motion of the touch position, etc. are detected by the touch panel 17B. The digitizer 17C is an electromagnetic induction type pointing device for inputting on the screen of the LCD 17A. A touch position (coordinates) of the pen 100 on the screen, the motion of the position of the pen 100, etc. are detected by the digitizer 17C. The digitizer 17C outputs coordinates indicating the position of the pen 100 on the screen.

The wireless communication device 107 is a device which is formed to execute wireless communication such as wireless LAN or 3G mobile communication. The EC 108 is a one-chip microcomputer including an embedded controller for power management. The EC 108 has a function of powering on or off the tablet computer 10 in accordance with a user's operation on a power button.

As the background, this embodiment relates to a stylus pen for inputting in an electronic device. The stylus pen is a pen for inputting in a device such as a tablet or a notebook PC. For writing with a pen on the screen, a material used in consideration of invasiveness so as not to damage the screen or a material durable against abrasion caused by writing is used as a pen core material.

Polyacetal (POM) is used for lots of stylus pens currently available on the market. In this case, the user may feel hard to write because the stylus pen is slippery when the user performs writing with the stylus pen. It has been found from a result of measurement of friction resistance that the value of friction resistance obtained by writing with the stylus pen is greatly smaller than that obtained by conventional writing with paper and pen.

For this reason, use of a high friction coefficient material as the pen core material has been discussed in order to increase the resistance value and improve the usability so as to be equivalent to that on paper. When a high friction material is used, the pen tip becomes larger than that of a plastic material such as POM because of durability, etc. Because use of the large pen tip in the stylus pen makes it difficult to write a small character when writing is performed on the display, it is sufficiently likely that the paper writing feeling may be spoiled.

In this embodiment, a small character can be written easily because such a special shape as not to obstruct the visual view or a marker to make a touch point easily recognized is prepared in the pen core even when such a high friction coefficient material that the shape of the pen tip is enlarged is used.

For example, this embodiment uses thermoplastic elastomers and resins having high friction resistance values, as the high friction coefficient material for the pen core of the stylus pen. For example, the thermoplastic elastomers include styrene-butadiene-styrene block copolymer (SBS), styrene-isoprene-styrene block copolymer (SIS), styrene-ethylene/butylene-styrene block copolymer (SEBS), styrene-ethylene/propylene-styrene block copolymer (SEP S), polyolefin-based thermoplastic elastomer, natural rubber (NR), isoprene rubber (IR), butadiene rubber (BR), styrene-butadiene rubber (SBR), chloroprene rubber (CR), nitrile rubber (NBR), butyl rubber (IIR), acrylic rubber (ACM), silicone rubber, etc. Each of these thermoplastic elastomers may be used singly or a mixture of two or more kinds of these thermoplastic elastomers may be used. These thermoplastic elastomers may be mixed with the resins.

As the pen core material, durability against abrasion is also required in addition to high friction. The pen core attached to the stylus pen may be fixed or may be of a refill type so that the pen core can be replaced. Devices using the stylus pen correspond to various devices such as a tablet, an electronic book, etc.

Examples of the embodiment will be described below.

### EXAMPLE 1

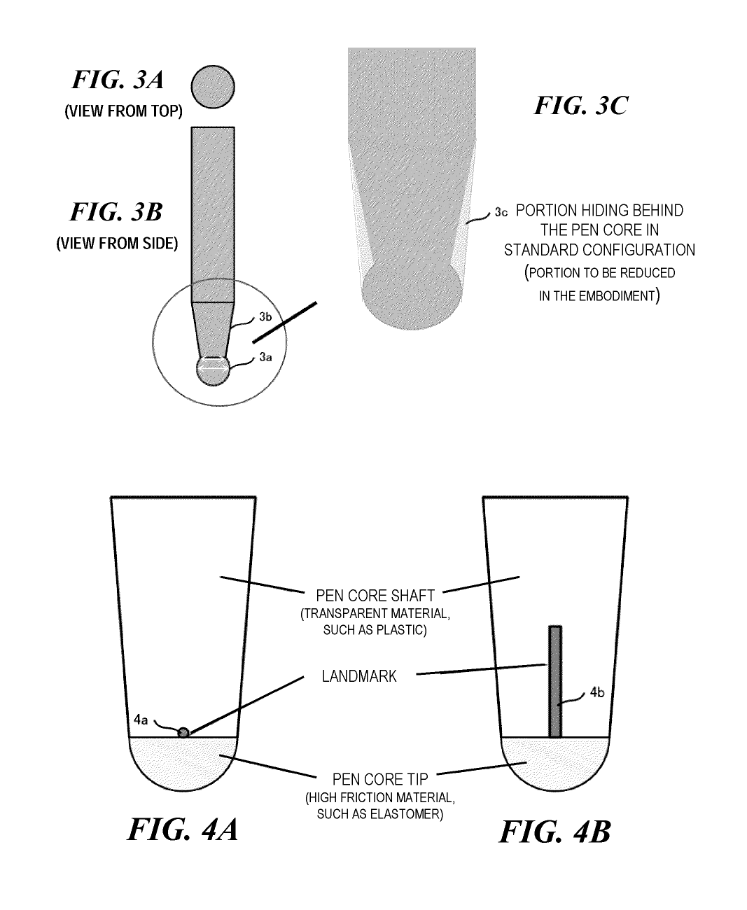

A stylus pen (pen) 100 according to a first example of the embodiment will be described with reference to FIGS. 3A to 3C. FIGS. 3A to 3C cross-sectionally show the pen tip of the stylus pen according to the first example of the embodiment. FIG. 3A is a sectional shape which is viewed from the base end (the top) when the pen is erected vertically and which is a rotationally symmetrical circular shape. FIG. 3B shows a sectional shape which is viewed from the side when the pen is erected vertically and which is a line-symmetrical shape. FIG. 3C is an enlarged explanatory view of a region surrounded by a circle in FIG. 3B.

As shown in FIG. 3B, the pen core is formed so that a spherical tip portion 3a and a conical shaft portion 3b are connected to each other at a place shorter than the diameter of the spherical shape. In a manner of speaking, because a narrow portion is provided in this place so that a portion 3c where the pen core hides the screen in FIG. 3C is reduced compared with the standard structure, a small character can be written more easily than that with a conventional pen. For example, the pen core may not have a rotationally symmetrical circular section as described above but have a polygonal section. The shaft with respect to the tip portion may be configured to have a core holder structure in which the shaft and the tip portion can be detached from each other easily. For example, the narrow portion may function as a touch point clarifying structure.

### EXAMPLE 2

A stylus pen according to a second example of the embodiment will be described with reference to FIGS. 4A and 4B. FIGS. 4A and 4B cross-sectionally show the pen tip of the stylus pen according to the second example of the embodiment. As shown in FIGS. 4A and 4B, the pen core tip portion is made of a high friction material, and the pen core shaft portion is made of a transparent material such as plastic. A landmark (mark for indicating a touch point) is inscribed in the pen core shaft portion. Although two kinds of landmark shapes 4a and 4b are shown in FIGS. 4A and 4B respectively, any other shape may be used. A place where writing is made on the display can be recognized easily by the landmark so that a small character can be written easily. For example, the landmark may function as a touch point clarifying structure.

### EXAMPLE 3

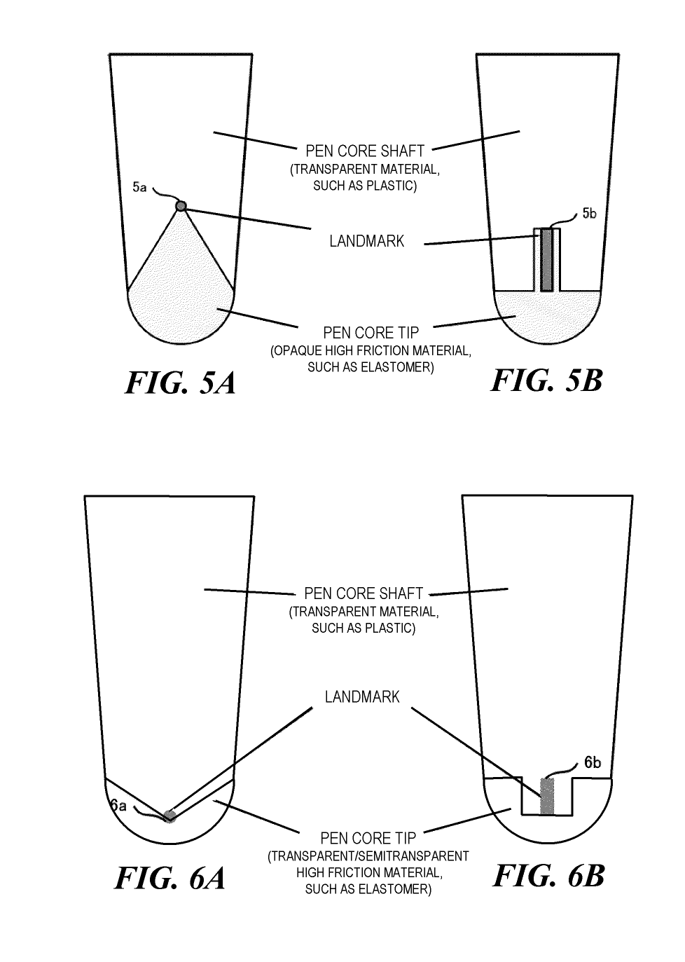

A stylus pen according to a third example of the embodiment will be described with reference to FIGS. 5A and 5B. FIGS. 5A and 5B cross-sectionally show the pen tip of the stylus pen according to the third example of the embodiment. As shown in FIGS. 5A and 5B, the pen core tip portion is made of a high friction material, and the pen core shaft portion is made of a transparent material such as plastic. The pen core tip portion has a bulge portion (a portion of the pen core tip portion which goes into the pen core shaft portion) so that the pen core tip portion is hardly separated from the pen core shaft portion to thereby enhance durability in use, compared with FIGS. 4A and 4B. Landmarks 5a and 5b are inscribed in the pen core shaft portion, similarly to FIGS. 4A and 4B. Any other shape may be used as the landmark shape. A place where writing is made on the display can be recognized easily by the landmark so that a small character can be written easily.

### EXAMPLE 4

A stylus pen according to a fourth example of the embodiment will be described with reference to FIGS. 6A and 6B. FIGS. 6A and 6B cross-sectionally show the pen tip of the stylus pen according to the fourth example of the embodiment. As shown in FIGS. 6A and 6B, the pen core tip portion is made of a transparent or semitransparent high friction material, and the pen core shaft portion is made of a material such as plastic. The pen core shaft portion has a bulge portion (a portion of the pen core shaft portion which goes into the pen core tip portion) so that the pen core tip portion is hardly separated from the pen core shaft portion to thereby enhance durability in use, compared with FIGS. 4A and 4B. Landmarks 6a and 6b are inscribed in the pen core shaft portion, similarly to FIGS. 4A and 4B. Any other shape may be used as the landmark shape. A place where writing is made on the display can be recognized easily by the landmark so that a small character can be written easily.

### EXAMPLE 5

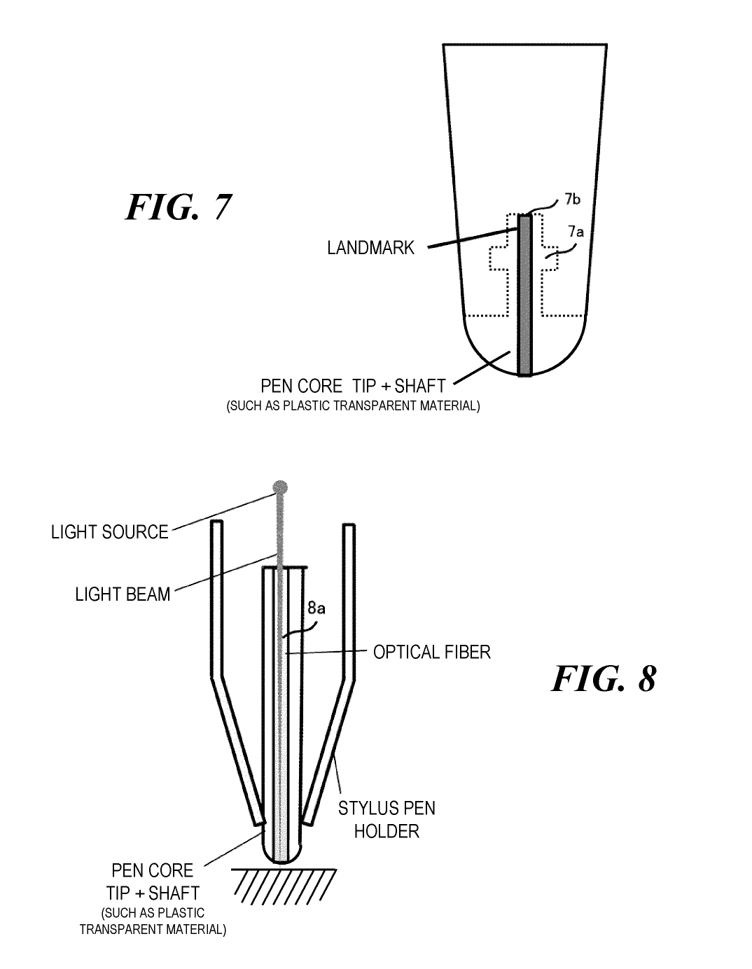

A stylus pen according to a fifth example of the embodiment will be described with reference to FIG. 7. FIG. 7 cross-sectionally shows the pen tip of the stylus pen according to the fifth example of the embodiment. As shown in FIG. 7, the pen core tip portion is made of a transparent or semitransparent high friction plastic material, and the pen core shaft portion is made of a plastic material likewise. The pen core tip portion may have a disk-shaped portion 7a so that the pen core tip portion is not separated from the pen core shaft portion to thereby enhance durability in use, compared with FIGS. 4A and 4B. A landmark 7b is inscribed in the pen core front end portion. Any other shape may be used as the landmark shape. A place where writing is made on the display can be recognized easily by the landmark so that a small character can be written easily.

### EXAMPLE 6

A stylus pen according to a sixth example of the embodiment will be described with reference to FIG. 8. FIG. 8 cross-sectionally shows the pen tip of the stylus pen according to the sixth example of the embodiment. As shown in FIG. 8, in this example, the stylus pen has a built-in light source which projects a light beam onto the pen core shaft portion made of a transparent material such as plastic to thereby form a landmark 8a. Because both the pen core shaft portion or shaft portion and the tip portion need transmit the light beam without diffusion, it is preferable that a material of an optical fiber etc. is used for an optical path. A place where writing is made on the display can be recognized easily by the landmark so that a small character can be written easily. For example, the light source may function as a touch point clarifying structure.

In the background art, a high friction coefficient material is used, so that the pen tip becomes large in accordance with the material for the sake of durability, etc. Because use of the large pen tip in the stylus pen makes it difficult to write a small character at the time of writing on the display, it is sufficiently likely that the feeling of writing on paper may be spoiled. To solve this problem, a part of the pen core is sharpened or a marker indicating the center of the pen core is added to thereby make the touch point of the pen core clear so that writing a small character with the pen can be equivalent to that with a ball point pen.

### <Points of the Embodiment>

(1) A pen core for stylus pen in a stylus pen used as an input pen in a tablet input device, wherein: the pen core for stylus pen is made of a high friction material, and the point where the pen core performs inputting is indicated clearly.
(2) A pen core for stylus pen, wherein: the pen core is formed so that a spherical tip portion and a conical shaft portion are connected to each other.
(3) A pen core for stylus pen, wherein: an axis indicating the center is inscribed in the inside of the pen core.
(4) A pen core for stylus pen, wherein: a light source is provided in the inside of the pen core so that light emitted from the light source indicates an input point of an input device.

As described above, according to the embodiment, a small character can be written easily because a special shape not to obstruct the visual view or a marker to make a touch point easily recognized is prepared in the pen core even when such a high friction coefficient material that the shape of the pen tip is enlarged is used.

Incidentally, the invention is not limited to the aforementioned examples and various modifications may be made on the invention without departing from the gist thereof.

Constituent elements disclosed in the aforementioned examples may be combined suitably to form various inventions. For example, some constituent elements may be removed from all constituent elements disclosed in each example. In addition, constituent elements disclosed in different examples may be combined suitably.

1. A stylus pen configured to be used as an input pen in a tablet input device, the stylus pen comprising:
a pen tip comprising a high friction material, wherein a portion of the pen tip comprises an approximately spherical shape;
a touch point; and
a touch point clarifying structure configured to enhance a visibility of the touch point of the stylus pen to a touching object.

2. The stylus pen of claim 1, further comprising:
a pen shaft connected with the pen tip,
a connection portion between the pen shaft and the pen tip, the connection portion comprising a narrow portion,
wherein the narrow portion comprises the touch point clarifying structure.

3. The stylus pen of claim 1, further comprising:
a landmark at approximately a center of the stylus pen, wherein the landmark comprises an inscription in the pen tip at a position opposite to the touch point or on the pen shaft,
wherein the landmark comprises the touch point clarifying structure.

4. The stylus pen of claim 1, further comprising:
a light source configured to emit a light beam,
wherein the pen tip is configured to guide the light beam toward the touching object,
wherein the touch point clarifying structure comprises the light source.

5. An information device comprising:
a tablet face; and
a stylus pen configured to be used as an input pen on the tablet face, the stylus pen comprising:
a pen tip comprising a high friction material, wherein a portion of the pen tip comprises an approximately spherical shape;
a touch point; and
a touch point clarifying structure configured to enhance a visibility of the touch point of the stylus pen to a touching object.
